(19) United States
(12) Patent Application Publication
(10) Pub. No.: US 2015/0314219 A1
(43) Pub. Date: Nov. 5, 2015

(54) Partition for Limiting a Clarification Chamber of a Small Sewage Treatment Plant

(71) Applicant: ATB Umwelttechnologien GmbH, Porta Westfalica (DE)

(72) Inventor: Markus Baumann, Bad Oeynhausen (DE)

(21) Appl. No.: 14/698,185

(22) Filed: Apr. 28, 2015

(30) Foreign Application Priority Data
May 2, 2014 (DE) 202014102055.1

(51) Int. Cl. B01D 21/00; B29C 49/00; E03F 5/18; C02F 3/28

(52) U.S. Cl. CPC B01D 21/0033; C02F 3/28; B01D 21/0003; B29C 49/0031; E03F 5/18; C02F 2203/006; B29L 2024/00

(57) ABSTRACT

A partition (42) for forming the boundary of a clarification chamber (12, 32) of a small sewage treatment plant, includes at least a wall element (44, 46, 48) and one or more hollow bodies (56, 58, 60) for conducting or storing fluids, which are mounted at the wall element (44, 46, 48), in which the hollow body or bodies (56, 58, 60) is or are integrated into the wall element (44, 46, 48) or integrally molded to the latter, and are produced from a plastic in one piece with the wall element (44, 46, 48) by a blow molding method or a rotational melting method.

The present invention relates to a partition for limiting a clarification chamber of a small sewage treatment plant of the introductory portion of claim 1.

Small sewage treatment plants are used, for example, for purifying the sewage of households, which are not connected to, the public sewer system. They may comprise several chambers, particularly a preliminary clarification chamber for the preliminary clarification of sewage and a biological clarification chamber, in which the actual final biological purification of the sewage with activated sludge takes place. The preliminary clarification chamber and the biological clarification chamber may be disposed in a common container and are separated by a partition, over which the biological clarification chamber is supplied from the preliminary clarification chamber. For the sake of simplicity, the various chambers of the small sewage treatment plant in the present specification are referred to as clarification chambers, since the precise function of the preliminary clarification or the final biological cleaning does not matter in the sense of the present invention.

The EP 2 641 876 A1 is referred to here as an example of a small biological sewage treatment plant of a new construction. These and similar installations require functional elements for conveying sewage from a clarification chamber into a different one or one for the interim storage of sewage. These functional elements comprise pipes, containers or hollow bodies for conducting or storing fluids, the containers or hollow bodies usually being mounted at a wall element of the partition, which forms the boundary of a clarification chamber or of several clarification chambers from one another. Typical components of this type are mammoth lifters or the parts thereof, which are suspended at the partition, buffering, containers, sample containers or sections of pipe, passed through the partition.

A large number of components must be installed for constructing such a small sewage treatment plan. Naturally, this makes the installation time-consuming and costly. In an endeavor to save time and costs, the construction of previous small sewage treatment plant is to be simplified even further. In particular, the number of components, which has to be installed, is to be reduced.

It is therefore an object of the present invention to simplify a small sewage treatment plant of the type described above by reducing the number of the individual components thereof, which must be installed, and to save time and costs during the installation in this manner.

In accordance with the invention, this objective is accomplished by a partition, having the features of claim 1, for limiting a clarification chamber of a small sewage treatment plant.

For the inventive partition, the hollow body or bodies for conducting or storing fluid are no longer mounted subsequently at the wall element; instead, they are formed in one piece with the latter in such a way, that the hollow body or bodies are integrated completely in the wall element or molded to the wall element. The wall element and the hollow body are produced, in this case, from a thermoplastic material by means of a blow molding method or a rotational melting procedure. Due to this integration, work processes for producing parts of the small sewage treatment plant become superfluous and the installation is also simplified.

In accordance with a preferred embodiment of the present invention, at least one of the hollow bodies is integrated in such a manner in the wall element, that the plane of the wall intersects the hollow body. For example, this hollow body may be a pipe, the axis of which lies in the plane of the wall. This saves space within the small sewage treatment plant, space, which was previously required for mounting a tubular hollow body on the outside of the wall element.

Furthermore preferably, at least one of the hollow bodies is a pipe or a container. For example, it may be a mammoth lifter or a part of the same, with a buffering or sample container, which is integrated in the upper region of the wall element in this or integrally molded to this.

In accordance with a further preferred embodiment of the invention, the partition comprises at least two first and second wall elements, which are disposed next to one another, the height of which corresponds to that of the partition and which are in contact with one another along an approximately vertical abutting edge.

In this case, the partition is formed by several wall elements, which have been assembled.

In a continuation of this development, the inventive partition furthermore, preferably comprises a third wall element, which is constructed, wedge-shaped and is inserted in a wedge-shaped recess between the first and the second wall elements. For example, this third wall element may be pushed from above into the wedge-shaped recess, in order to complete the partition.

Furthermore, preferably, the abutting edges between the wall elements are profiled as tongue and groove connections. In this case, therefore, the abutting edges are interlocked, which ensures that the individual parts of the partition are held securely.

In accordance with a further preferred embodiment of the present invention, the first and second wall elements comprise parts, which are identical with or symmetrical to one another. This represents yet another simplification of the manufacture of the wall elements. The first and second wall elements may, for example, be produced with an identical shape. A case is also conceivable here, in which superfluous parts at one of the two wall elements are removed before the installation or openings are closed off, so that the respective wall element can be adjusted to be ready for use.

The present invention furthermore comprises a small sewage treatment plant comprising a septic tank, the interior of which is divided into different clarification chambers by at least one partition of the inventive type.

In accordance with a preferred embodiment, the clarification chamber of this inventive small sewage treatment plant may be formed from plastic and have a manhole on its upper side; in this case, the interior is divided by the partition into two clarification chambers, the width of each wall element of the partition being smaller than the internal diameter of the manhole. This embodiment also optionally enables the retrofitting of a known small sewage treatment plant or the use of a conventional clarification container, which is divided by a partition of the inventive type.

In the following, preferred embodiments of the invention are explained in greater detail by means of the included drawing.

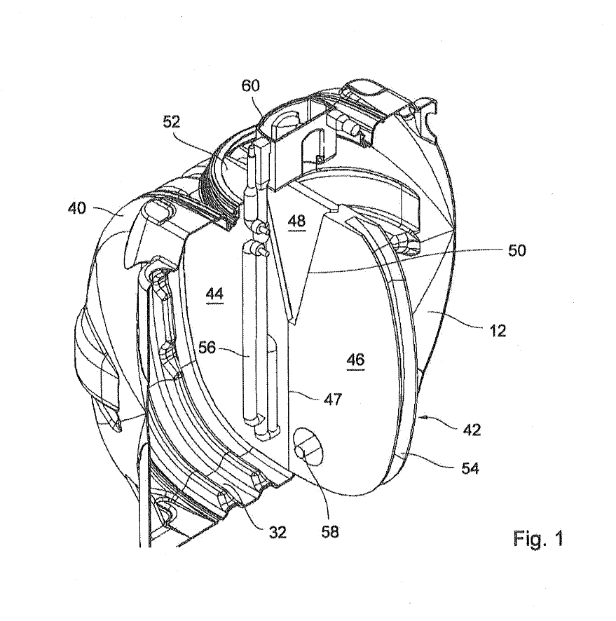

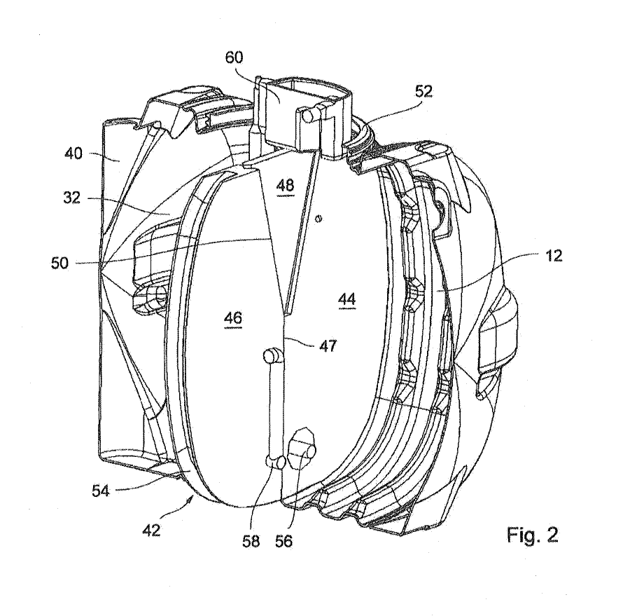

FIGS. 1 and 2 are perspective partial representations of a container of a small sewage plant, in which a partition of an embodiment of the present invention is used;

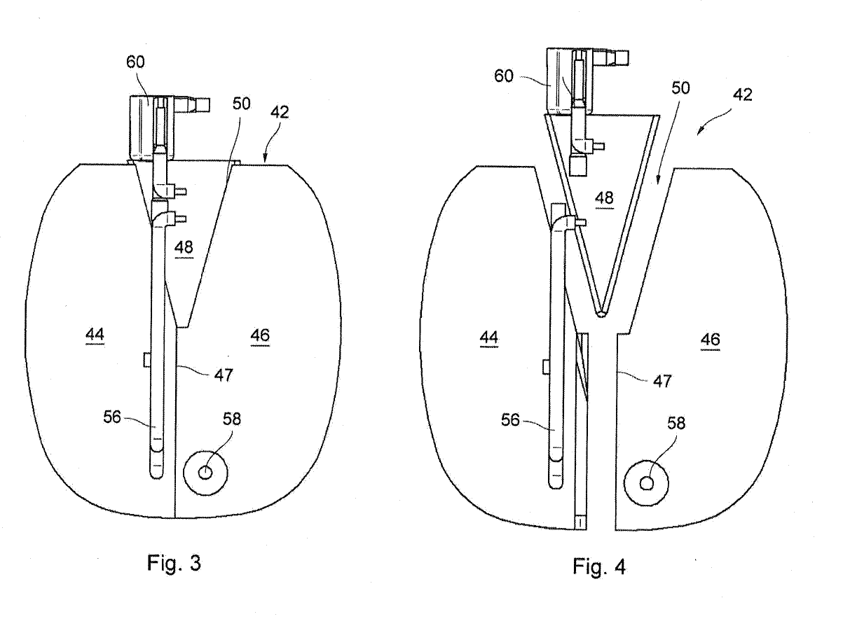

FIG. 3 is a front view of the partition of FIG. 1 and

FIG. 4 is a disassembled front view of the partition of FIGS. 1 and 2.

The container 40, partly shown in FIG. 1, represents a septic tank of a small biological sewage treatment plant. The container 40 is made of a synthetic thermoplastic material, for example, by blow molding and cut open in the representation in FIG. 1, the cutting plane being perpendicular to and extending in the longitudinal direction through the container 40. The interior of the container 40 is divided into two clarification chambers, namely into one rear clarification chamber 12, which forms a preliminary clarification chamber, and a front clarification chamber 32, which represents the actual, biological clarification chamber.

The small sewage treatment plant is constructed essentially like that described in EP 2 641 876 A1. The precise details of the course of the sewage process will not be dealt with here, since it is not a subject matter of the present invention.

The two clarification chambers are separated from one another within the container 40 by a partition 42, which extends transversely to the container 40. The partition 42 accordingly forms the boundary of the rear clarification chamber 12 and defines the latter from the front clarification chamber 32.

The partition 42 is divided into three wall elements, namely into a first and a second wall element 44, 46, which are disposed next to one another and are in contact with one another along a vertical abutting edge 47, and a third wedge-shaped wall element 48, which is inserted from above into a wedge-shaped recess 50 between the first wall element 44 and the second wall element 46. This division of the partition 42 into three wall elements 44, 46, 48 makes it easier to introduce the wall elements through a manhole 52 on the upper side of the septic tank 40. The width of each of the wall elements 44, 46, 48 is less than the internal diameter of the manhole 52. The abutting edges 47 between the first wall element 44 and the second wall element 46 as well as between the first wall element 44 and the third wall element 48 and the second wall element 46 and the third wall element 48 may be profiled as tongue and groove connections, so that the individual parts are held securely. There is also a grooved profile 54 at the sides and bottom at the first and second wall elements 44, 46. A rib at the inner wall of the septic tank 40, which is not shown in detail, can engage this grooved profile 54.

Each of the wall elements 44, 46, 48, which form this partition, is formed in one piece with hollow bodies, which conduct or store the fluid and are functional components of the small sewage treatment plant. In the present example, the first wall element 44 is formed in one piece with a mammoth lever 56 by a blow molding method or a rotational melt method, so that the mammoth lever 56 is molded to the first wall element 44, with which it forms one part. In the lower region of the second wall element 46, a pipe section 58 is disposed as a passage between the two clarification chambers 12, 32, the passage being formed in one piece with the second wall element 46, in which it is integrated. A buffer container 60 is molded in one piece with the third, wedge-shaped wall element 48, on the upper side thereof.

By this type of molding, the respective wall element 44, 46, 48 and the hollow body, formed therewith, are integrated completely into a single component. This facilitates installation appreciably and saves time and costs.

Deviating from the embodiment shown here, it is also possible to construct two wall elements for forming the partition 42 symmetrically or identically, so that they can be produced in a single mold. After it is molded, each of the wall elements, produced by these means, can be adapted individually to its function by processes such as cutting off superfluous parts, blocking pipe openings, etc. It is furthermore possible to construct the hollow body or bodies in the plane of the wall, in order to save space on the side surfaces of the wall elements 44, 46, 48.

FIG. 2 shows the septic tank 40 with the partition 42 of FIG. 1, perspectively, from a different viewing angle. In the front view of FIG. 3, the partition 42 is optional and, in FIG. 4, it is shown once again in the disassembled state.

What is claimed is:

1. A partition for forming the boundary of a clarification chamber of a small sewage treatment plant, comprising:
at least one wall element and
at least one hollow body for conducting or storing fluids, each of which is mounted at the at least one wall element,
the at least one hollow body is one of:
integrated into the at least one wall element and
integrally molded to the at least one wall element, and
the at least one hollow body is produced from a plastic in one piece with the at least one wall element by one of:
a blow molding method and
a rotational melting method.

2. The partition of claim 1, wherein at least one said hollow body is integrated in the at least one wall element, so the plane of the respective said wall element intersects the hollow body.

3. The partition of claim 1, wherein at least one said hollow body is one of:
a pipe and
a container.

4. The partition of claim 1, wherein the partition comprises at least two said wall elements including a first wall element and a second wall element which are disposed next to one another, and having a height of which corresponds to a height of the partition and which abut along an approximately perpendicular abutment edge.

5. The partition of claim 4, wherein the at least one wall element includes a third wall element, which is constructed wedge-shaped and is inserted in a wedge-shaped recess between the first and second wall elements.

6. The partition of claim 4, wherein the abutment edge is edges profiled between the wall elements as tongue and groove connections.

7. The partition of claim 4, wherein the first and the second wall elements are parts, which are one of:
identical with one another, and
at least symmetrical to one another.

8. A small sewage treatment plant, comprising a septic tank having an interior of which is divided by at least one partition in accordance with claim 1 into different clarification chambers.

9. The small sewage treatment plant of claim 8, wherein the septic tank is formed from a plastic and, on an upper side thereof, has a manhole, and an interior thereof is divided by the partition into two septic tanks, a width of each wall element being smaller than an internal diameter of the manhole.
